(19) United States
(12) Patent Application Publication
(10) Pub. No.: US 2005/0051926 A1
(43) Pub. Date: Mar. 10, 2005

(54) Production of articles by rotomolding

(76) Inventors: Gerard Guillot, Tassin (FR); Maria-Rosa Contardi, Mortara (PV) (IT); Jerome Therby, Saint-Chamond (FR); Christophe Lapierre, Jonage (FR)

Correspondence Address: BURNS DOANE SWECKER & MATHIS L L P, POST OFFICE BOX 1404, ALEXANDRIA, VA, 22313-1404, US

(21) Appl. No.: 10/875,552

(22) Filed: Nov. 16, 2004

Related U.S. Application Data
(60) Provisional application No. 60/515,641, filed on Oct. 31, 2003.

(30) Foreign Application Priority Data
Jun. 27, 2003 (FR) 03/07817

(51) Int. Cl. B29C 31/00

(52) U.S. Cl. 264/310; 264/85; 528/310

(57) ABSTRACT

The present invention relates to a process for producing polyamide articles by rotomolding and to articles manufactured by this process. The process according to the invention includes in particular a step in which a polyamide-based powder is introduced into a rotomolding mold. The articles obtained by rotomolding may be hollow parts without welds, such as, for example, articles selected from the group consisting of containers, vats, flasks, cisterns, cases, boxes, tanks, bumpers, seats and bodywork parts.

The present invention relates to a process for producing polyamide articles by rotomolding and to articles manufactured by this process. The process according to the invention includes in particular a step in which a polyamide-based powder is introduced into a rotomolding mold. The articles obtained by rotomolding may be hollow parts without welds, such as, for example, articles selected from the group consisting of containers, vats, flasks, cisterns, cases, boxes, tanks, bumpers, seats and bodywork parts.

The process of rotational molding, also called rotomolding, has been known for a very long time and allows hollow plastic articles to be manufactured.

This process consists in placing the plastic mass in a mold and rotating this mold such that all of the points on the inner surface of the mold are contacted with the plastic mass and then in heating the rotating assembly so as to deposit said plastic mass in melt form over the inner surface of the mold. Finally a cooling step allows the part to solidify, and it is subsequently removed from the mold.

Rotational molding is valued on account of the fact that it prevents the induction in the plastic of stresses such as those which may be encountered in injection-molded parts. This is because the plastic does not undergo such severe kneading or such severe compaction as in an extruder or an injection device. Rotomolding allows large-sized articles such as containers and tanks to be produced.

The plastic polymers mostly widely used for rotomolding are polyethylenes and polyvinyl chlorides (PVC).

Polyamides are not used very much for manufacturing articles by rotomolding. This is because the existing production processes do not allow the production of polyamide articles having homogeneous characteristics, such as a regular wall thickness. Consequently these articles have weak points in their structure, leading to a diminution of their mechanical properties. Moreover, the polyamide parts obtained by rotational molding possess a poor surface appearance.

The present invention relates to a process for producing polyamide-based articles by rotomolding in which a polyamide-based powder of fine granulometry which has a low moisture content is introduced into the mold.

The process according to the invention allows the abovementioned drawbacks to be avoided. This process allows the production of articles having homogeneous characteristics, such as, for example, a regular wall thickness in said articles. The articles obtained additionally have good mechanical properties. The articles obtained according to the invention also have a good inner and outer surface appearance, with no run, bubble or other defect. Furthermore, the temperature for rotomolding the powder of the invention can be reduced in relation to a conventional process.

The present invention provides a process for producing an article by rotomolding, in which at least one polyamide-based powder having the following characteristics:
i) the particle size of said powder is less than or equal to 500 μm, and
ii) said powder has a moisture content less than or equal to 0.65% by weight, is introduced into a mold.

The invention provides in particular a process for producing an article by rotomolding, which comprises at least the following steps:
a) placing in a mold at least one polyamide-based powder having the following characteristics:
   i) the particle size of said powder is less than or equal to 500 μm, and
   ii) said powder has a moisture content less than or equal to 0.65% by weight;
b) rotating the mold;
c) heating the mold;
d) cooling the mold and/or the article obtained; and
e) demolding the article.

The polyamides suitable for the invention are preferably composed of at least one (co)polyamide selected from the group consisting of (co)polyamide 6; 4; 11; 12; 4.6; 6.6; 6.10; 6.12; 6.18; 6.36; and copolymers and blends thereof. According to one preferred embodiment of the invention at least 90% by weight, preferably at least 99% by weight, of the repeating units of the macromolecular chains of the (co)polyamides are selected from repeating units of polyamide 6 and repeating units of polyamide 6.6.

Mention may be made for example of semicrystalline or amorphous polyamides, such as aliphatic polyamides, semiaromatic polyamides and, more generally, linear polyamides obtained by polycondensation of a saturated aliphatic or aromatic diacid and a saturated aromatic or aliphatic primary diamine, polyamides obtained by condensing a lactam, an amino acid, or linear polyamides obtained by condensing a mixture of these different monomers. More specifically these copolyamides may be, for example, polyhexamethyleneadipamide, polyphthalamides obtained from terephthalic and/or isophthalic acid, copolyamides obtained from caprolactam and one or more monomers generally used for preparing polyamides, such as adipic acid, terephthalic acid and/or hexamethylenediamine.

Preferably the (co)polyamide suitable for the invention has a melt flow index less than or equal to 25 g/10 min in accordance with standard ISO 1133 under a load of 2.16 kg at a temperature 10° C. above the melting point of the (co)polyamide.

According to one advantageous characteristic of the invention the polyamide-based powder may be composed of a mixture of a (co)polyamide with one or more other polymers. Consideration may be given to a mixture of (co)polyamide with at least one polymer of the polypropylene oxide (PPO), polyvinyl chloride (PVC), polyacrylo-butadiene-styrene (ABS), polyethylene (PE), polypropylene (PP) or (co)polyamide type.

Such a mixture may be made for example in the melt, by extrusion for example. Consideration may also be given to the mixture of a polyamide-based powder and a powder of another polymer.

According to the present invention the particle size of the polyamide-based powder is approximately less than or equal to 500 μm. Preferably at least 95% by weight of the particles of the polyamide-based powder according to the invention have a size less than or equal to 500 μm.

By particles are meant the granules, spherical and/or ovoid in shape in particular, which make up said powder. The size corresponds to the longest dimension of these particles. In the case of spherical particles the size corresponds to the diameter of these particles.

The particles of the polyamide-based powder according to the invention may have a size of between 100 and 500 μm. Preferably these particles have an average size of between 100 and 500 μm, more particularly between 200 and 500 μm. The particles of the polyamide-based powder advantageously have a mean diameter (Dm) of between 150 and 400 μm, more preferably between 200 and 350 μm. The mean diameter (Dm) of the particles may be measured according to the following relationship: Dm=Σ (Pi×Di), where Pi corresponds to the percentage of particles retained with a sieve and Di corresponds to the average size of the particles, in μm, on the sieve. This method of calculation is set out in standard ASTM D1921-96, method A.

To obtain a polyamide-based powder it is possible to use any physical and/or chemical process, such as, for example, the grinding of polyamide pellets. The polyamide pellets are generally obtained by chopping one or more shaped strands at the exit from an extruder. These pellets may be obtained directly after the step of polymerizing the polyamide.

The grinding of the polyamide pellets may be carried out by various types of grinding mills, such as, for example, a disk mill, a hammer mill, a toothed-roll mill or an electromagnetic mill, a piston mill for example.

Grinding may be cryogenic, which is to say that it is carried out at a temperature of between −10 and −200° C., preferably between −20 and −100° C. Cryogenic grinding makes it possible in particular to prevent the yellowing of the resulting articles and to obtain a high throughput of ground powder. Cryogenic grinding also makes it possible to produce a powder which contains no filaments, and which is thus particularly suitable for rotomolding.

Grinding can be carried out under an inert atmosphere, i.e., in the absence of oxygen, under nitrogen for example.

After grinding it is possible to measure and/or modify the granulometry of the powder using rotary classifiers. In order to determine the granulometry of a polyamide-based powder it is possible to use a “bulting” method, for example, using different-mesh-sized sieves, or a laser method.

To obtain a polyamide-based powder having a moisture content less than or equal to 0.65% by weight a number of methods can be used. For example the polyamide-based powder obtained beforehand can be dried by grinding. This drying may be carried out under vacuum or dry air, at a temperature of 80° C. for example. The dry air used advantageously has a dew point lower than −40° C.

According to one preferred embodiment of the invention the cryogenic grinding as defined above also makes it possible to obtain a polyamide-based powder having a low moisture content, without carrying out an additional drying step. This is because the polyamide-based powder may have a moisture content less than or equal to 0.65% by weight on its exit from cryogenic grinding. Preferably the polyamide-based powder according to the invention has a moisture content less than or equal to 0.5% by weight, more preferably of between 0.2 and 0.4% by weight, in particular less than 0.35% by weight. The moisture content may also be less than 0.2% by weight.

The polyamide-based powder may subsequently be placed in an impervious bag so as to preserve its moisture content until it is used for rotomolding. The polyamide-based powder may also be dried immediately prior to its use for rotomolding.

The moisture content of a polyamide-based powder can be determined using the Fisher method in accordance with standard ISO 15512 1999 (F), method B.

Rotomolding is a process well known to the skilled worker. The various processes of rotational molding generally include the following steps: mold filling, mold rotation, mold heating, cooling, and demolding.

The mold is generally rotated about two perpendicular axis.

The amount of molding powder introduced into the mold may be variable in accordance with the size of the article it is desired to obtain and the thickness of its walls.

The step of mold heating, also called the molding step, takes place according to the invention in step c). The heating temperature may vary form 190 to 400° C. In general a molding temperature is used which is at least greater by 10° C. than the melting point of the (co)polyamide it is desired to mold. For molding it is possible to use a temperature of between 230 and 350° C., preferably between 250 to 300° C. For the rotomolding of polyamide 6 it is possible with the process according to the invention to use temperatures of between 250 and 270° C.

The duration of molding varies according to the size of the article. It can be between 10 and 30 minutes, preferably in the region of 15 minutes. The duration and the time of cooling depend on the rotomolder's plant and the size of the article to be molded. As referred to above, it is possible to cool the mold and/or the article present in the mold. To cool the mold it is possible to ventilate the outside of the mold with air, for example at 25° C., and/or with atomized water. In order to cool the article inside the mold it is possible to inject air and/or atomized water into the mold, for example at 25° C.

The cooling time varies generally between 10 and 20 minutes. The article is generally demolded when it has a temperature of between 70 and 120° C., preferably between 80 and 100° C.

Rotomolding may be carried out under an inert gas in the absence of oxygen. In order to do this it is possible, for example, to add a compound which releases carbon dioxide, such as dry ice, to the mold together with the polyamide-based powder. The dry ice generates carbon dioxide in the gaseous state during the heating step of molding. It is also possible to carry out a nitrogen purge, by injecting nitrogen after closing the mold.

The polyamide-based powder may further comprise various compounds, fillers, agents and/or additives. Numerous methods may be considered of mixing the (co)polyamides of the invention with these compounds, fillers, agents and/or additives. They may be added to the polyamide powder, or to the pellets, before, during or after the grinding step. They may for example be mixed with the powder after grinding, using a mixer, before introduction into the mold. They may also be introduced as a mixture with the (co)polyamide in the melt state before the pellets are produced. Some of these compounds, fillers, agents and/or additives may be added during the polymerization of the (co)polyamide. Consideration may also be given to adding these compounds, fillers, agents and/or additives to the mold with the polyamide-based powder.

The pellets used according to the invention and/or the polyamide-based powder may therefore comprise antioxidants and/or light, heat and/or UV stabilizers. These additives are described for example in the work titled “Oxidation, Inhibition in Organic Materials”, edited by Jan Pospisil and Peter P. Klemchuk (1990), or in European patent application no. 0610155.

By way of example mention may be made, as antioxidants suitable for the invention, of compounds containing sterically hindered phenol functions, in simple or oligomeric form (such as Irganox 1098 from Ciba-Geigy), monophenols unsubstituted or substituted by alkyl groups, such as 2,6-di-tert-butyl-4-methylphenol or the like; hydroquinones unsubstituted or substituted by alkyl groups, such as 2,6-di-tert-butyl-4-methoxyphenol; hydroxyl-containing thiophenyl ethers such as 2,2′-thiobis(6-tert-butyl-4-methylphenol); bisphenols unsubstituted or substituted by alkyl groups, such as 2,2′-methylenebis(6-tert-butyl-4-methylphenol); benzene compounds such as 1,3,5-tri(3,5-di-tert-butyl-4-hydroxybenzyl)-2,4,6-trimethylbenzene; acylated aminophenols; hindered amines such as N,N′-diisopropyl-p-phenylenediamine, phenothiazine, 1,4-benzothiazine or the like.

It is also possible to use what are called “secondary” antioxidants, such as compounds containing phosphite functions (such as Irgafos 168 from Ciba-Geigy), aliphatic or aromatic phosphonites, and alkali metal salts of phenylphosphonic acid or of hypophosphorous acid.

As light stabilizers or UV absorbers mention may be made, by way of examples, of 2-(2′-hydroxyphenyl)benzotriazoles such as 2-(2′-hydroxy-5-methylphenyl)benzotriazole or the like; 2-hydroxy-benzophenones such as 3,3′-methylenebis(2-hydroxy-4-methoxybenzophenone); substituted or unsubstituted benzoic esters such as bis(4-tert-butyl-benzoyl)resorcinol; acrylates; compounds containing sterically hindered amine functions in simple or oligomeric form (such as Tinuvin 770 from Ciba-Geigy); diamides of oxalic acid, hydroxyphenyl-s-triazines; and nickel compounds such as the complexes of nickel with 2,2′-thiobis-4-(1,1,3,3-tetramethylbutyl)phenol.

When one of these additives is present in the composition its weight concentration is between 0.05% and 5% approximately, relative to the polyamide-based powder.

The pellets using according to the invention and/or the polyamide-based powder may further comprise:
reinforcing and/or bulking fillers preferably selected from the group consisting of fiber fillers such as glass fibers, metallic fibers, carbon fibers, mineral fillers such as clays, kaolin, or nanoparticles providing reinforcement or in thermoset material, and powder fillers such as talc.
impact modifiers, such as ethylene-propylene (EP), ethylene-propylene-diene terpolymer (EPDM), elastomeric copolymers such as styrene-maleic anhydride (SMA), for example, ultra low-density polyethylene (ULDPE), linear low-density polyethylene (LLDPE), styrene-ethylene-butadiene-styrene (SEBS), polypropylene (PP), acrylic elastomers (such as polyacrylic elastomers), ionomeric elastomers, acrylonitrile-butadiene-styrene terpolymer (ABS) and acrylic-styrene-acrylonitrile terpolymer (ASA). The impact modifiers may optionally contain grafted groups such as maleic anhydride, for example. It is possible in particular to use maleic anhydride grafted onto ethylene-propylene-diene monomer. The impact modifiers according to the invention may also be combinations, mixtures, homopolymers, copolymers and/or terpolymers of the above-mentioned compounds; and/or
additives, for example, flame retardants, matting agents (TiO₂), lubricants, plasticizers, compounds useful for catalyzing the synthesis of the polymer matrix, antistats, pigments such as carbon black, dyes, molding additives or surfactants.

The present invention also provides all the uses of a polyamide-based powder having the above-mentioned characteristics for producing articles by rotomolding.

The present invention likewise provides articles obtainable by the process described above.

The articles obtained by the rotational molding process according to the invention contain no weak point and possess good mechanical properties. The articles according to the invention have in particular a good bursting strength.

The articles obtained by rotomolding are generally hollow parts without welds, such as, for example, articles selected from the group consisting of containers, vats, flasks, cisterns, cases, boxes, tanks, bumpers, seats and bodywork parts.

These articles may include openings and/or plastic or metal inserts.

The walls of the articles may be composed of one or more successive layers, possibly of different types. Thus it is possible by this process to produce articles whose walls contain, for example, two or three layers. It is possible for example to manufacture articles having an inner and outer layer of (co)polyamide, of like or different type, optionally comprising antioxidants and/or light, heat and/or UV stabilizers, fillers, impact modifiers, additives and adjuvants. It is also possible to manufacture articles having an inner layer of (co)polyamide and an outer layer of polyethylene (PE) and/or polypropylene (PP).

A number of known methods exist for producing articles whose walls have a number of layers by rotomolding. It is possible, for example, to introduce a mixture of (co)polyamides and/or polymers having different melting points and to mold at different temperatures in order to obtain a multilayer structure. It is also possible to mold each additional layer before the preceding layer is cooled.

Other details and advantages of the invention are illustrated by the manufacturing examples, which are given, below, solely by way of indication.

Materials Used:

PA 6 pellets: melt flow index (MFI) according to standard ISO 1133 at 230° C. under a load of 2.16 kg is 18 g/10 min. The polyamide 6 has a terminal acid group content of 80 meq/kg and a terminal amino group content of 42 meq/kg. Viscosity index of 140 ml/g, measured in formic acid in accordance with standard ISO 307.
Tinuvin 770, sold by the company Ciba-Geigy. Light stabilizer containing two hindered piperidines.
Irganox B 1171, sold by the company Ciba-Geigy. 50% mixture of a hindered phenolic antioxidant (Irganox 1098) and a phosphite (Irgafos 168).

### EXAMPLE 1

### Production of Polyamide 6 Powder

The various processes for producing polyamide 6 powder or pellets are mentioned in table 1 below.

The moisture content by weight is measured by the Fisher method according to standard ISO 15512 1999 (F), method B.

Test 1: Pellets of polyamide 6 as defined above with a length of 2.5 mm are cryogenically ground under inert gas at −60° C., in the total absence of oxygen, with a double toothed-roll mill. During cryogenic grinding, 0.25% by weight of Tinuvin 770 and 0.25% by weight of Irganox B 1171, relative to the total weight of the powder, are added to the polyamide powder by means of a metering balance coupled with a screw. The polyamide 6 powder is subsequently screened using a sieve containing holes of 500 μm. The particle size distribution of the polyamide 6 powder, measured by laser with a Mastersizer 2000 from Malvern Instruments, is as follows:

| Particle | Weight |
|---|---|
| size (μm) | percentage (%) |
| >500 | 0 |
| 315-500 | 50 |
| 200-315 | 35 |
| 10-200 | 11 |
| <100 | 4 |

The polyamide 6 powder thus contains particles having a mean diameter (Dm) according to standard ASTM D1921-96, method A, of 314 μm.

The polyamide 6 powder has a moisture content of 0.2% by weight.

Test 2: Polyamide 6 powder is produced from polyamide 6 pellets using a counterrotating-disk mill at ambient temperature under atmospheric air. This gives a powder consisting of particles having an average size of between 100 and 500 μm (mean diameter (Dm) of 325 μm), by classifying. 0.25% by weight of Tinuvin 770 and 0.25% by weight of Irganox B 1171 are added, relative to the total weight of the powder. The powder is dried in a vacuum oven. This gives a moisture content 0.20% by weight.

Test C1: Polyamide 6 powder is produced from polyamide 6 pellets using a disk mill at ambient temperature under atmospheric air. This gives a powder consisting of particles having an average size of between 100 and 500 μm (mean diameter (Dm) of 325 μm), by classifying. 0.25% by weight of Tinuvin 770 and 0.25% by weight of Irganox B 1171 are added, relative to the total weight of the powder. The undried powder has a moisture content 0.70% by weight.

Test C2: Unground polyamide pellets with a length of 2.5 mm are used. These pellets have a moisture content of 0.20% by weight. 0.25% by weight of Tinuvin 770 and 0.25% by weight of Irganox B 1171 are added, relative to the total weight of the pellets.

Test C3: Polyamide 6 powder is produced from polyamide 6 pellets using a disk mill at ambient temperature under atmospheric air. This gives a powder consisting of particles having an average size of between 200 and 650 μm (mean diameter (Dm) of 416 μm), by classifying. 0.25% by weight of Tinuvin 770 and 0.25% by weight of Irganox B 1171 are added, relative to the total weight of the powder. The powder is dried in a vacuum oven.

This gives a moisture content 0.20% by weight.

### EXAMPLE 2

### Production of Articles by Rotomolding

The various powders of example 1 are placed separately in molds for rotomolding.

The rotomolding parameters are as follows:
container mold 70 cm long and 20 cm in diameter
molding temperature: 260° C.
duration of molding: 18 minutes
rotational speed: 5 revolutions/minute for the first axis and 7 revolutions/minute for the second axis
cooling time: 13 minutes (cooling by injection of air to the outside of the mold)

The articles obtained weigh 1.8 kg. The articles obtained are evaluated for external appearance, internal appearance and regularity of their thickness. It should be noted that the parts obtained with the powder C1 are brittle on demolding.

The results are recorded in the table below:

TABLE 1

| Polyamide- | Results for the molding | | |
|---|---|---|---|
| based | external | internal | regularity of |
| power | appearance | appearance | thickness |
| 1 | good | good | good/good |
| 2 | good | good | good/good |
| C1 | bubbles and flash | bubbles and | poor/poor |
| | | flash | |
| C2 | bubbles and | bubbles and | poor/poor |
| | unmelted powder | unmelted powder | |
| C3 | good | unmelted powder | moderate/poor |

The internal and external surface appearance is determined by cutting pieces of walls of the articles. The surface appearance of these pieces is observed under a microscope.

The surface appearance is classified as follows:
good: signifies that under the microscope no bubbles or a very small proportion of bubbles having a diameter between 0.2 and 0.3 mm is observed.
bubbles and flash: signifies that a high proportion of bubbles having a diameter of between 0.2 and 0.3 mm is observed.
unmelted powder: signifies that the powder has not melted completely and that residues of powder greater than 500 μm in size are observed.

In the column headed “regularity of thickness”, the first observation corresponds to the regularity of thickness for one article; the second observation corresponds to the regularity of thickness on 3 articles.

The regularity of the thickness for an article is determined by measuring the thickness of 10 wall pieces collected by cutting from one article.
good: signifies that the variation in the thickness of the article is between 0 and 20%, relative to the average thickness of this article.
moderate: signifies that the variation in the thickness of the article is between 20 and 50%, relative to the average thickness of this article.
poor: signifies that the variation in the thickness of the article is greater than 50%, relative to the average thickness of this article.

The regularity of the thickness on three articles is determined by measuring the thickness of 30 wall pieces collected by cutting from three articles (10 pieces per part).
good: signifies that the variation in the thickness is between 0 and 20%, relative to the average thickness of the three articles.
moderate: signifies that the variation in the thickness is between 20 and 50%, relative to the average thickness of the three articles.
poor: signifies that the variation in the thickness is greater than 50%, relative to the average thickness of the three articles.

1. Process for producing an article by rotomolding, in which at least one polyamide-based powder having the following characteristics:
i) the particle size of said powder is less than or equal to 500 μm, and
ii) said powder has a moisture content less than or equal to 0.65% by weight, is introduced into a mold.

2. Process according to claim 1, comprising at least the following steps:
a) placing in a mold at least one polyamide-based powder having the following characteristics:
i) the particle size of said powder is less than or equal to 500 μm, and
ii) said powder has a moisture content less than or equal to 0.65% by weight;
b) rotating the mold;
c) heating the mold;
d) cooling the mold and/or the article obtained; and
e) demolding the article.

3. Process according to claim 1 or 3, characterized in that the polyamide is composed of at least one (co)polyamide selected from the group consisting of (co)polyamide 6; 4; 11; 12; 4.6; 6.6; 6.10; 6.12; 6.18; 6.36; and copolymers and mixtures thereof.

4. Process according to any one of claims 1 to 3, characterized in that at least 90% by weight of the repeating units of the macromolecular chains of the (co)polyamides are selected from repeating units of polyamide 6 and repeating units of polyamide 6.6.

5. Process according to any one of claims 1 to 3, characterized in that the (co)polyamide has a melt flow index less than 25 g/10 min according to standard ISO 1133 under a load of 2.16 kg at a temperature 10° C. above the melting point of the (co)polyamide.

6. Process according to any one of claims 1 to 5, characterized in that the particles of the polyamide-based powder have an average size of between 100 and 500 μm.

7. Process according to any one of claims 1 to 6, characterized in that the particles of the polyamide-based powder have a mean diameter (Dm) of between 150 and 400 μm, preferably between 200 and 300 μm.

8. Process according to any one of claims 1 to 7, characterized in that the moisture content of the polyamide-based powder is less than or equal to 0.5% by weight.

9. Process according to any one of claims 1 to 8, characterized in that the moisture content of the polyamide-based powder is between 0.2 and 0.4% by weight.

10. Process according to any one of claims 1 to 9, characterized in that the polyamide-based powder is obtained by cryogenic grinding at a temperature of between −10° C. and −200° C.

11. Process according to claim 10, characterized in that the cryogenic grinding is carried out under an inert atmosphere.

12. Process according to any one of claims 2 to 11, characterized in that the temperature in step c) is between 230 and 350° C.

13. Process according to any one of claims 2 to 11, characterized in that the temperature in step c) is 250 to 300° C.

14. Process according to any one of claims 1 to 13, characterized in that the rotomolding is carried out under an inert gas.

15. Process according to any one of claims 1 to 14, characterized in that the polyamide-based powder comprises at least one compound selected from the group consisting of an antioxidant and a light, heat and/or UV stabilizer.

16. Process according to any one of claims 1 to 15, characterized in that the polyamide-based powder comprises at least reinforcing and/or bulking fillers, impact modifiers, and/or additives.

17. Article obtainable by the process of production by rotomolding according to any one of claims 1 to 16.

18. Article according to claim 17, characterized in that it is selected from the group consisting of containers, vats, flasks, cisterns, cases, boxes, tanks, bumpers, seats and bodywork parts.

19. Polyamide-based powder for producing articles by rotomolding, having the following characteristics:
i) the particle size of said powder is less than or equal to 500 μm, and
ii) said powder has a moisture content less than or equal to 0.65% by weight.
